(19) United States
(12) Patent Application Publication
(10) Pub. No.: US 2010/0306983 A1
(43) Pub. Date: Dec. 9, 2010

(54) METHOD OF ATTACHING AN ELEMENT TO A CONTINUOUSLY MOVING ELONGATED ARTICLE

(76) Inventor: ROBERT EUGENE BROOKS, Hacienda Heights, CA (US)

Correspondence Address: ROBERT E. BROOKS, 855 WEST SECOND STREET, POMONA, CA, 91766, US

(21) Appl. No.: 12/479,800

(22) Filed: Jun. 6, 2009

(51) Int. Cl. B23P 17/04

(52) U.S. Cl. 29/428

(57) ABSTRACT

An automatic, precision, fast, sequacious, economical method of attaching an informational element, like a label, completely around the perimeter of a continuously extruded or drawn, elongated article that is in the midst of its manufacture, constantly moving in a linear motion in its longitudinal axis, without stopping. The outer surface of the continuously extruded or drawn, elongated article has corrugations, roughness, comprising alternating ridges, strands and grooves which can not be written on directly with readable printing, making a label the only way to obtain a readable, informational element.

### CROSS-REFERENCES TO RELATED APPLICATIONS

This application claims priority from U.S. Provisional Application Ser. No. 60/941,737, filed on Jun. 4, 2007; U.S. Provisional Application Ser. No. 60/985,643, filed on Nov. 5, 2007; U.S. Provisional Application Ser. No. 60/985,978, filed on Nov. 6, 2007; and from U.S. Provisional Application Ser. No. 61/020,392 filed on Jan. 10, 2008, U.S. patent application Ser. No. 12/133,355 filed Jun. 4, 2009, which are hereby incorporated herein by reference in the respective entirety of each.

### TECHNICAL FIELD

The present invention relates to a method of attaching a label and wrapping a label, which is an informational element, completely around the perimeter of a continuously extruded or drawn, elongated article that is constantly moving in a linear motion in its longitudinal axis, without stopping. Examples of these articles that are constantly moving in a linear motion without stopping do to the manufacturing processes that produces them are: electrical armored cable, ropes albeit metal wire, plastic, wood boards, synthetic or natural fiber ropes, cables, wires, conduits, conductors, hoses, tubes, rods, belts, cords, fibers, aluminum or any other extrusion or any other continuously extruded, elongated articles that are manufactured without stopping during the labeling or marking procedure.

### BACKGROUND OF THE INVENTION

The subject invention generally relates to labeling and wrapping a label more than 360 degrees around the outer surface of a continuously manufactured, extruded, drawn, elongated article that is constantly moving in a linear motion without stopping, such as in the manufacturing of fiber optic cable, rope or metal wire rope, electrical cable, armored cable, wire, conductor, hose, tube, rod, belt, conduit, cord, metal extrusions, chain, etc. of any cross sectional shape. Prior to this invention, an automatic, precision, fast, cost effective acceptable method of attaching, wrapping and overlapping the edges of a label around a continuously manufactured, extruded, elongated article that is constantly moving in a linear motion without stopping, was never invented. Doing this process by hand is dangerous, sloppy and extremely costly. Printing and painting was used to add informational media to the extruded, drawn, elongated article but the characters are unreadable on the rough, corrugated, convoluted, woven, reticulated surfaces of the article that is constantly moving. Painting, which is another wet medium during application, has only been done with patterns like rings, stripes, dots, etc. and cannot produce readable characters on the rough surfaces of the continuously manufactured, elongated article that is constantly moving.

### BRIEF SUMMARY OF EMBODIMENTS OF THE INVENTION

According to one embodiment of the invention, an elongated article such as rope, cable, wire, conductor, hose, tube, rod, belt, chain, cord of round, oval, rectangular or other cross sectional shape, comprises an outer surface having a helical shape comprising of alternating twisting fibers, strands or wires that create ridges and grooves disposed on the outer surface; and a informational element having a body, the body having an attaching side having possibly an adhesive disposed thereon, the attaching side attachable to the helical ridges and spanning across the helical grooves.

The labels may be called a tag, sticker, marker, decal, plate, canvass, brand, for identifying a continuous processed elongated article that is constantly moving.

In a variant of the informational element, the body has a thickness for maintaining the stiffness of the body across the grooves. This informational element can also be called a label.

In another variant, the informational element is comprised of polyolefin, other plastics, paper or metal.

In a further variant, the informational element is electrically conductive.

In still another variant, the informational element may have electrically conductive adhesive on the attaching side.

In yet a further variant, the informational element further comprises a human or machine readable side containing human recognizable indicia and/or colors thereon, or emblazoned with human and/or machine readable markings, colors, spots, stripes, holograms, etc.

In another variant, the human or machine recognizable indicia comprises alpha numeric characters, OCR, bar codes or no indicia at all.

In a further variant, a method is configured to attach an adhesive type informational element to a moving elongated article.

In yet another variant, the method is configured to attach the informational element to an elongated article, moving along its long axis.

In still another variant, the method is configured for affixing an elongated article or label to an informational element moving in a direction parallel to the informational element's or label's axis. The label has front and back sides and a perimeter. The method is configured to affix the label to the elongated article in a manner in which the label wraps completely around the circumference of the elongated article. The method may comprise: a push up movement or stroke that pushes the label and rolls it, contours it, configures it so it's received on a moving elongated article; a first roll down action downstream of the push up stroke disposed lateral to the moving elongated article and configured to fold down a side of a label onto the elongated article; a second roll down action downstream of the first roll down action disposed lateral to the moving elongated article on a side opposite to the first roll down action and configured to fold down a side of a label onto the moving elongated article; and an opposed push down action configured to receive a moving elongated article.

In another variant, the method is configured to affix the label to the moving elongated article in a manner in which the back side of the label is partially flush with an outer surface of the elongated article.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is an illustration of a preferred result of the method invented, a labeled elongated article;

FIG. 2 is perspective view of a labeled elongated article or metal armored cable with flexible sheath and wire conductors inside;

FIG. 2A depicts a roller forming part of a method for affixing labels to a moving rope or armored electrical cable;

FIG. 2B depicts a roller and a label with holes disposed thereon attached to the rope or cable;

FIG. 3 depicts a partial side view of an apparatus configured to use the method for affixing labels to a continuously moving, drawn, extruded article like rope or cable;

FIG. 4 illustrates an overview of an alternate configuration of operation of the components of the method for attaching labels to a continuously moving, drawn, extruded article like rope and cable, illustrated in FIGS. 5-10;

FIG. 4A illustrates an overview of an alternate configuration of operation of the components of the method for attaching labels to a continuously moving, drawn, extruded article like rope and cable, illustrated in FIGS. 5-11;

FIG. 5 depicts a bottom push up roller and a peel blade;

FIG. 6 depicts the state of a label after being operated on by a first roll down roller;

FIG. 7 depicts a first roll down roller in operation;

FIG. 8 depicts a second roll down roller in an initial stage of operation;

FIG. 9 depicts a second roll down roller in a subsequent stage of operation;

FIG. 10 depicts a top push down roller in operation;

FIG. 11 depicts a heat tunnel component of the apparatus for affixing and tightening labels to a moving rope or cable;

FIG. 12 depicts FIGS. 12A-12G, which depict an operational flow diagram of an embodiment of an apparatus using the method for affixing labels to a moving rope;

FIG. 12A is a front view of a bottom push up roller in operation;

FIG. 12B is a front view of first and second roll down rollers in operation;

FIG. 12C is a front view of a member for pushing a label to one side in operation;

FIG. 12D is a front view of a top push down roller in operation;

FIG. 12E is a cross sectional view of a label with sides positioned upward with disparate heights;

FIG. 12F is a cross sectional view of a tamp pad in an initial stage of operation;

FIG. 12G is a cross sectional view of a tamp pad in a subsequent stage of operation;

FIG. 13 depicts FIGS. 13A-13K, which depict an operational flow diagram of a preferred embodiment of an apparatus configured to use the method for affixing labels to a moving rope or cable;

FIG. 13A depicts a tamp pad;

FIG. 13B depicts labels moving onto the tamp pad perpendicular to the direction of motion of the rope;

FIG. 13C depicts a tamp pad with a label disposed thereon moving upward toward a moving rope;

FIG. 13D depicts a tamp pad attaching a label to a moving rope;

FIG. 13E depicts a label after it is attached to the rope by the tamp pad;

FIG. 13F depicts a bottom push up roller in operation;

FIG. 13G depicts a first roll down roller in operation;

FIG. 13G1 depicts an alternative embodiment for pressing down a label to a moving rope;

FIG. 13H depicts the label after being operated on by the first roll down roller;

FIG. 131 depicts a second roll down roller in operation;

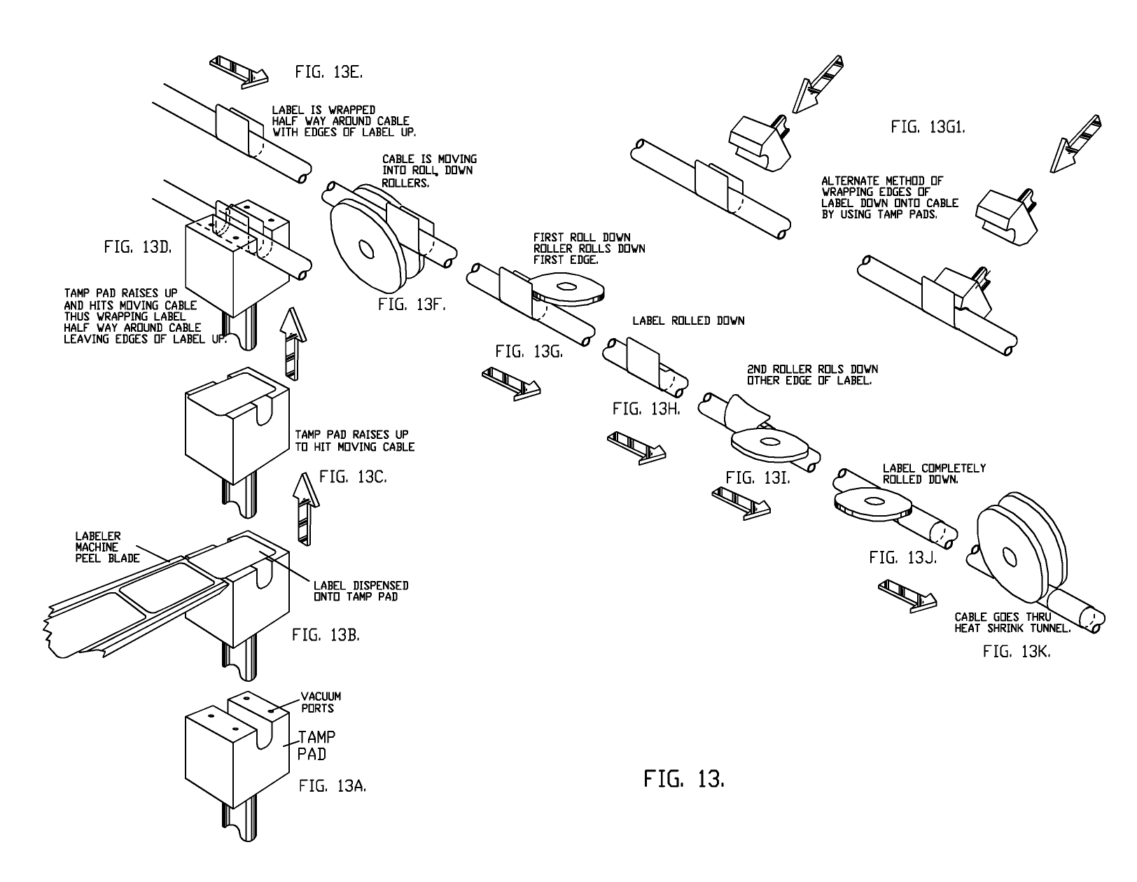

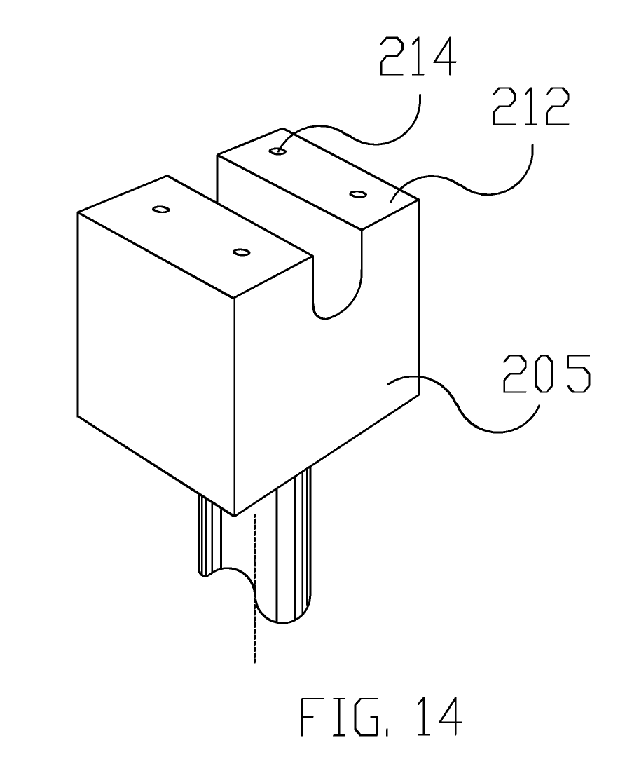

FIG. 13J depicts the second roll down roller in a later stage of operation;

FIG. 13K depicts a top push down roller in operation; and

FIG. 14 is a perspective view of a tamp pad having vacuum ports.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of these example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

The present invention is directed toward a method for affixing an informational element or label to any moving, elongated article in continuous motion or rope like article, and more particularly some embodiments are directed to labeling helically twisted rope or metal wire rope or armored electrical cable or corrugated cable.

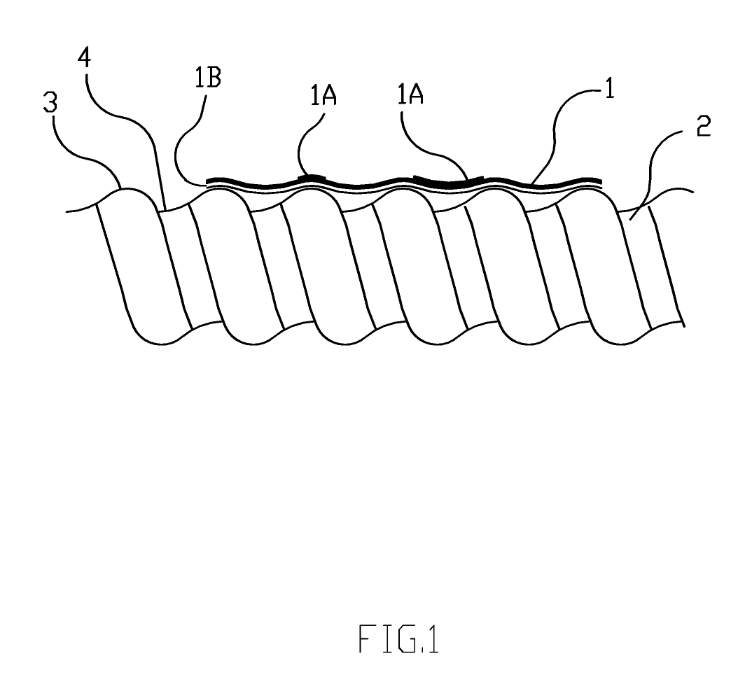

In one embodiment, referring to FIG. 1, a smooth, attachable, printable label 1 is affixed to the surface of armored electrical cable 2. The label has a label body 1 that bridges across the helical grooves 4 adjacent to and alternating between the helical ridges 3 of the surface of the armored electrical cable. The body of the label 1 may wrap around the armored electrical cable more than 360 degrees for best retention to the armored electrical cable. The label body may have an adhesive on the side of the label that attaches to the armored electrical cable 2 and should be of a thickness that prevents the label from dipping down into the helical grooves 4 of the surface when it is attached to the armored electrical cable. The adhesion of the label to the helical ridges 3 permits the label to conform to the circumference of the surface and stay attached to the helical ridges of the surface. In a preferred embodiment, the thickness of the label is between 1.5 to 2.0 mil. When the body of the label is wrapped around the rope more than 360 degrees, it will overlap itself and adhere to part of itself, which provides more adherence and longevity of its life and purpose which, in one embodiment, is to display information regarding the armored electrical cable, however any type of information may be displayed. The body of the label after it is attached to the surface of the armored electrical cable, provides a continuous surface with a relatively flat configuration that may serve as a canvass to paint on.

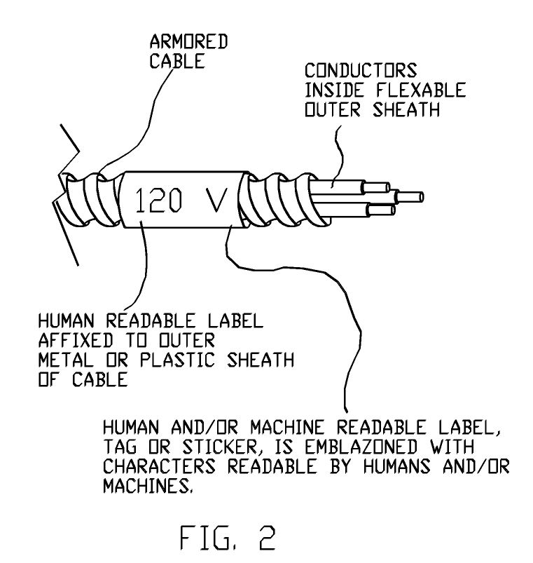

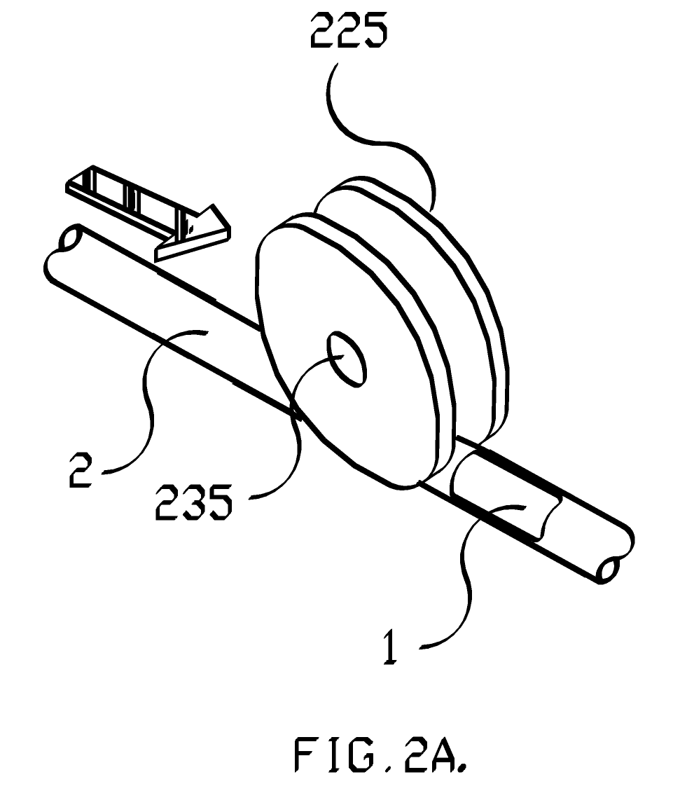

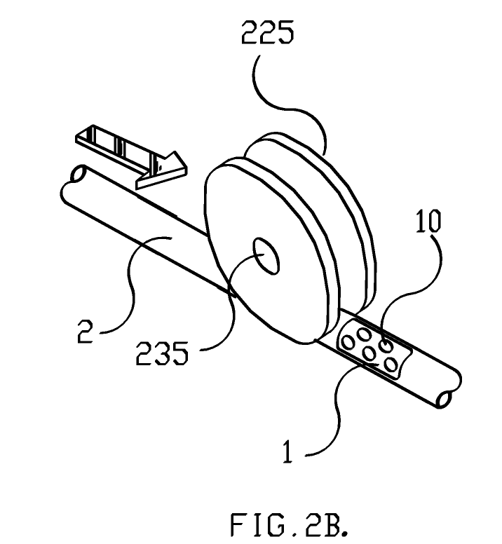

In another embodiment, referring to FIG. 2b, the label has holes 10 disposed throughout the label that penetrate completely through. When the label is placed on the armored electrical cable or metal wire rope 2, the holes 10 serve to prevent the label 2 from impeding the flow of electrical current.

In an example implementation of the invention shown in FIG. 2, an armored electrical cable includes several internal conductors and a readable label affixed and displayed on the outer surface of the armored electrical cable that is emblazoned with letters of any alphabet. In this example, there is no need to print information on the rope itself, which is probably impossible, as the label provides the substrate for printing on as a canvass provides a substrate to paint on.

Persons who install or maintain a labeled armored electrical cable in accordance with the embodiments of the invention, can quickly and instantly read the labels to identify the country of origin, mfr, usage and strengths in the particular types of armored electrical cable, such as their classification, code, gauge, lubrication, maintenance notes, voltage rating, etc., even though they may not know the construction material or be able to see the internal strands or conductors. Knowing the type or function of a given cable without seeing the internal strands, and without having to memorize a code, can save time and reduce hazards.

Referring to FIG. 1, to indicate that the armored electrical cable or metal wire rope is of the particular type, a label is affixed around the circumference of the outer surface of the armored electrical cable or metal wire rope. In one example, the label 1 has writing 1A on it to coincide with the material and to indicate the type of usage of the armored electrical cable, thus relieving the person looking for information pertinent to the armored electrical cable from having to have knowledge in deciphering a code for armored electrical cable, that may for example include a colored strand, dots, dashes, stripes, bands, solid colors, and any other patterns and indicia requiring a particular knowledge, for armored electrical cable, if any such identification system exists in order to quickly obtain information regarding the armored electrical cable.

A sequence of labels can be repeated all along the length of the armored electrical cable. In one embodiment, labels may be placed on successive sections of a fiber rope or metal wire rope as it is dispensed from a forming machine and just before the rope is wound onto a take up reel, ready for shipping.

In the case of a labeling method that applies the label to a moving rope that has a very short distance before it enters the take up reel machine, the labeling method must be able to apply labels quickly and to apply and cure or shrink the label in a short time between when the rope appears out of the forming machine to when it is wound onto the shipping reel.

The labels may be called a tag, sticker, marker, decal, plate, canvass, brand, informational element, for identifying a continuous processed rope or metal wire rope, cable, wire, conductor, hose, tube, rod, belt, chain, cord of round, oval, rectangular or other cross sectional shape, that is attached to the outside surface at certain intervals and are emblazoned with human and/or machine readable markings or indicia, colors, spots, stripes, holograms, etc.

In another embodiment, depicted in FIG. 2a, the label body may wrap around the rope less than 360 degrees around the outer surface of a continuous processed rope or metal wire rope, cable, wire, conductor, hose, tube, rod, belt, cord of any cross sectional shape.

In a further embodiment, the label body does not attach continuously along the length of said rope or metal wire rope, cable, wire, conductor, hose, tube, rod, belt, cord of a particular cross sectional shape but is attached at certain intervals and thus requires the tag, label, to be of certain length along the rope or metal wire rope, cable, wire, conductor, hose, tube, rod, belt, cord of said cross sectional shape.

In one implementation of affixing a label to a rope in accordance with the present invention is attaching the label onto the rope after the rope is being manufactured, for example, after being stranded and helically twisted and shaped.

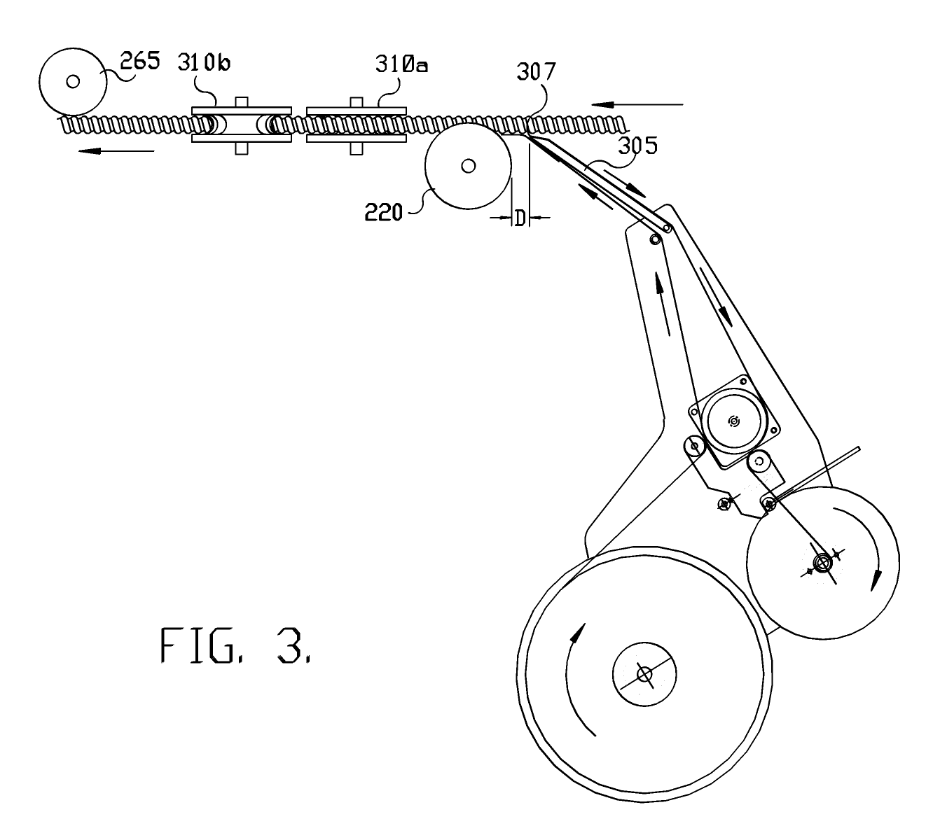

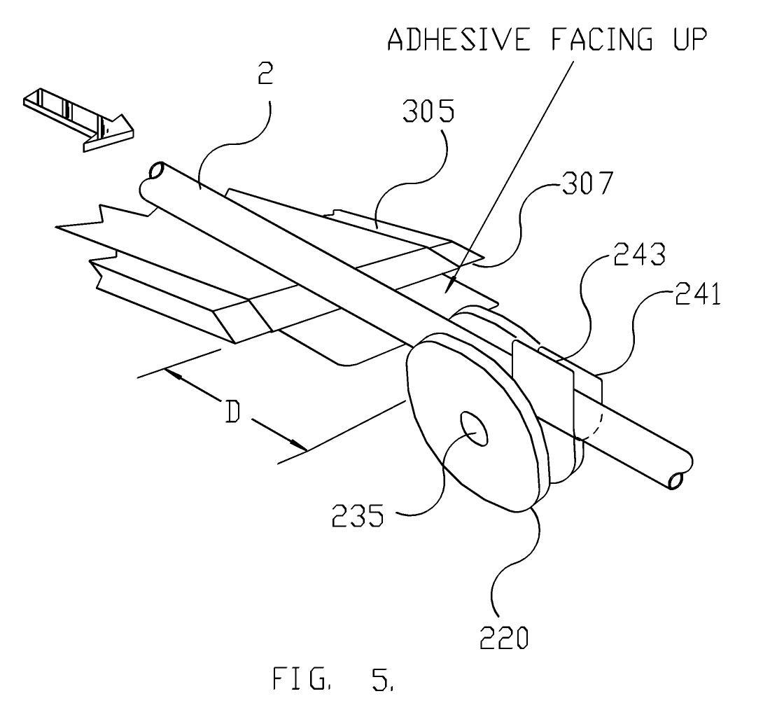

FIGS. 3-10a depict one embodiment of a method for affixing one or more labels to a rope moving in line with the rope's axis. The labels have front and back sides and a perimeter. Referring to FIG. 3, the method includes a label dispenser having a speed of dispensing labels that is adjustable and synchronized with the linear speed of the moving rope. A push up roller 220 is separated by a distance D from an edge 307 of a peel blade 305 of the dispenser. The distance D is determined based on the stiffness of a label as it detaches from its backing strip. The distance D will necessarily be less than the length of a label 1. The labels 1 dispense with the adhesive side facing up as shown in FIG. 5. In one example, the dispenser and the peel blade 305 are positioned to dispense and peel labels 1 in the same direction as the motion of the rope 2 moving along its axis.

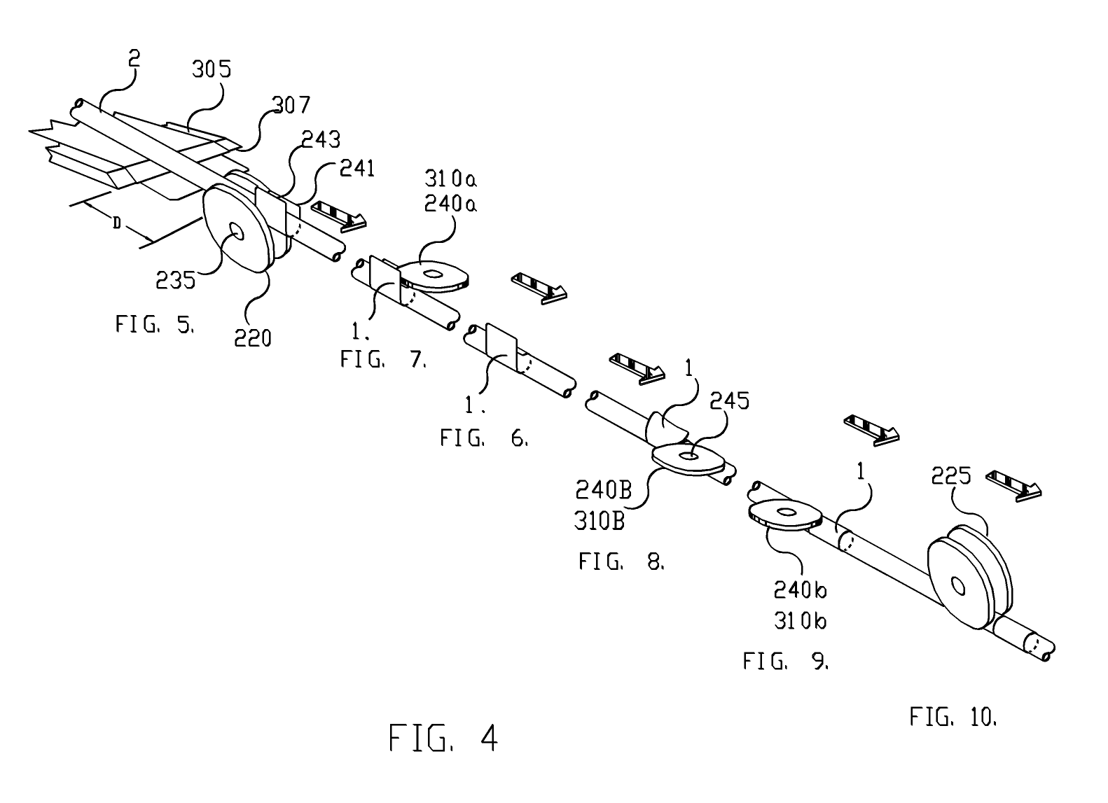

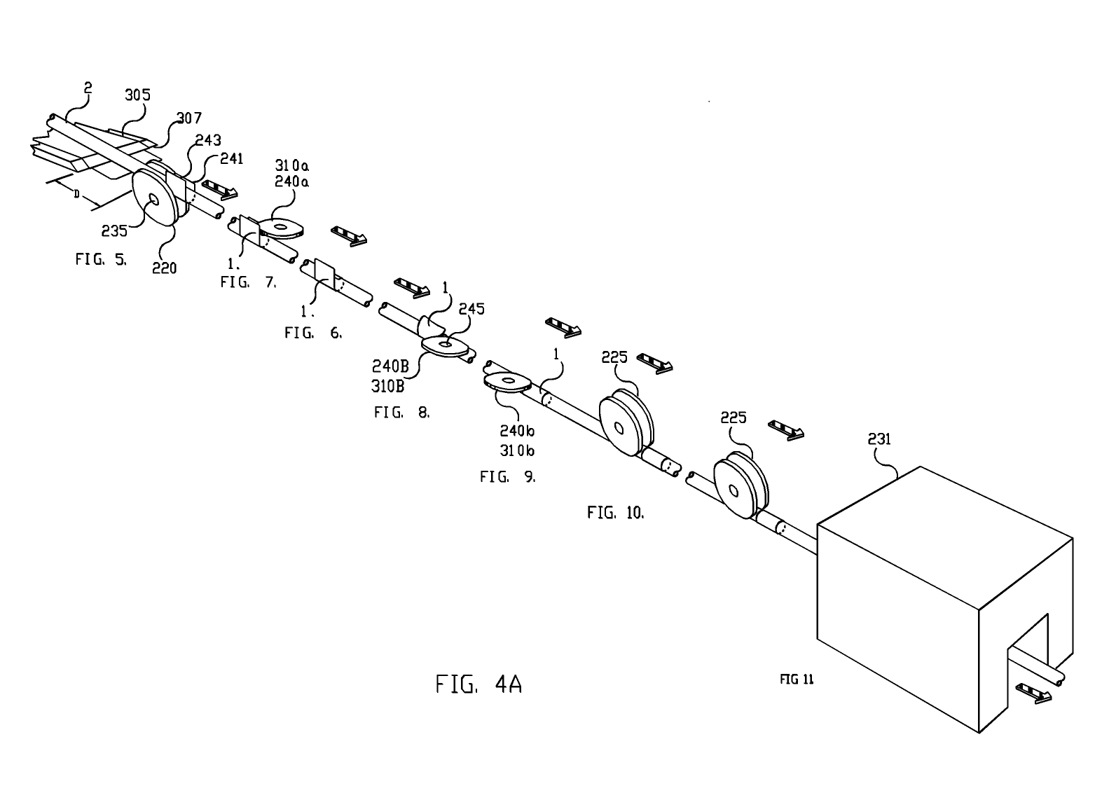

In one embodiment, the rope 2 may be positioned to move over the peel blade 305 at a point along the edge 307 so that the label will form an unequal U shape around the rope when received by the bottom push up roller 220. Referring to FIG. 4A and FIGS. 5-11, depending on the point where the rope moves over the labels 1 moving off the peel blade, is positioned, the disparity 242 in height of the sides 241, 243 of the label as it is formed into a U shape may be adjusted. For example, if the rope is centered on the labels, the sides 241, 243 of the sides of the U shape label will be equal in height. As the rope is positioned further from a center line of the labels, the more unequal the heights of the sides 241, 243 will be when folded up into the U shape.

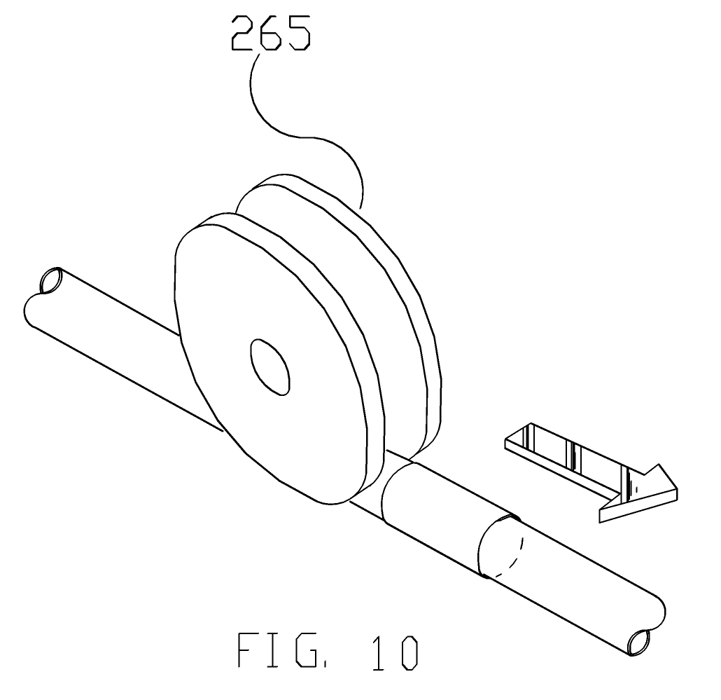

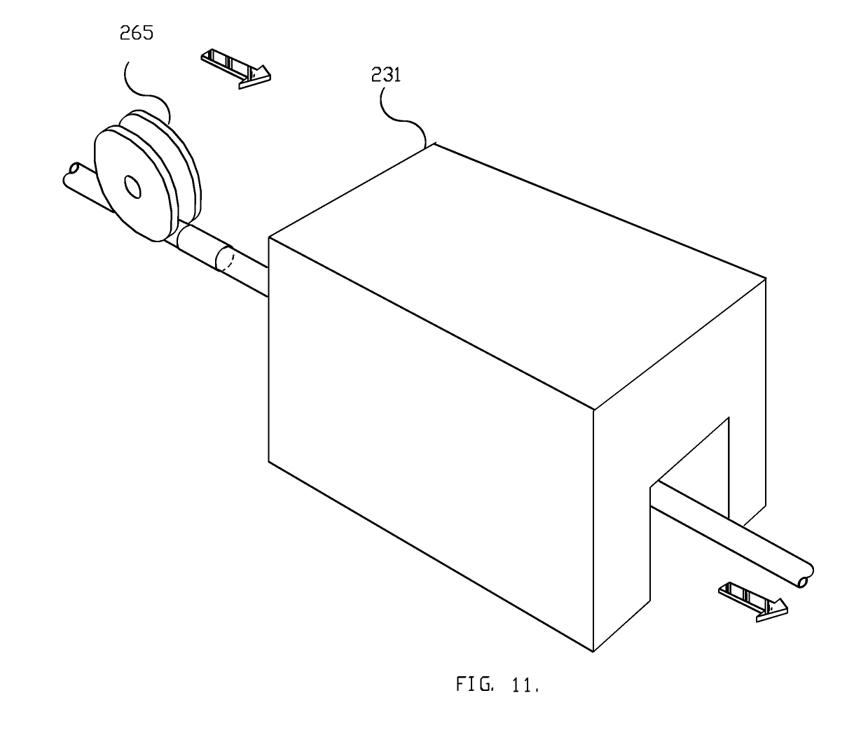

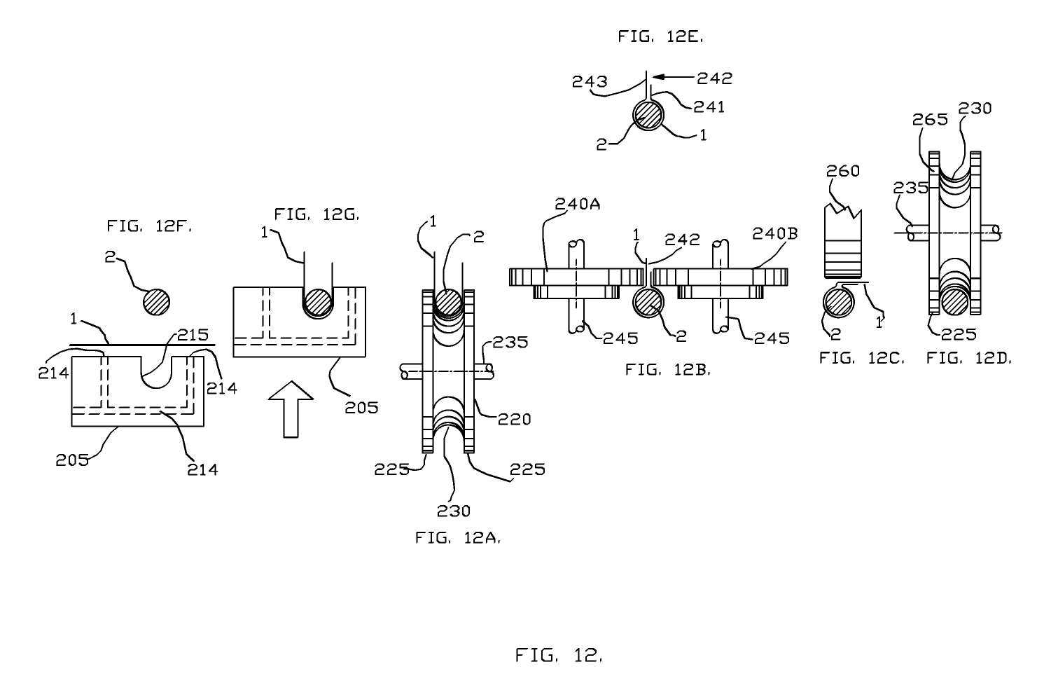

Referring to FIGS. 5 and 12, the bottom push up roller 220 has a channel 230 configured for receiving a rope 2 to be labeled, and the channel 230 is bounded by side walls 225. The roller 220 is configured for folding a label into a U shape around the rope as the rope and label enter the roller 220. The roller 220 is rotatable about its axis 235 and the axis 235 is perpendicular to the direction of travel of the rope 2. The bottom push up roller 220 is disposed below the moving rope 2 so the cable moves between the side walls 225. The side walls may assist in affixing the adhesive backed label to the rope 2. Do to the continuous movement of the extruded article, the label attaches to the extruded article do to friction and contact with the attaching side of the informational element and travels off of the grooved tamp pad 205 and the grooved tamp pad returns to a lowered position away from the moving rope 2 and another adhesive backed label may be dispensed onto the tamp pad.

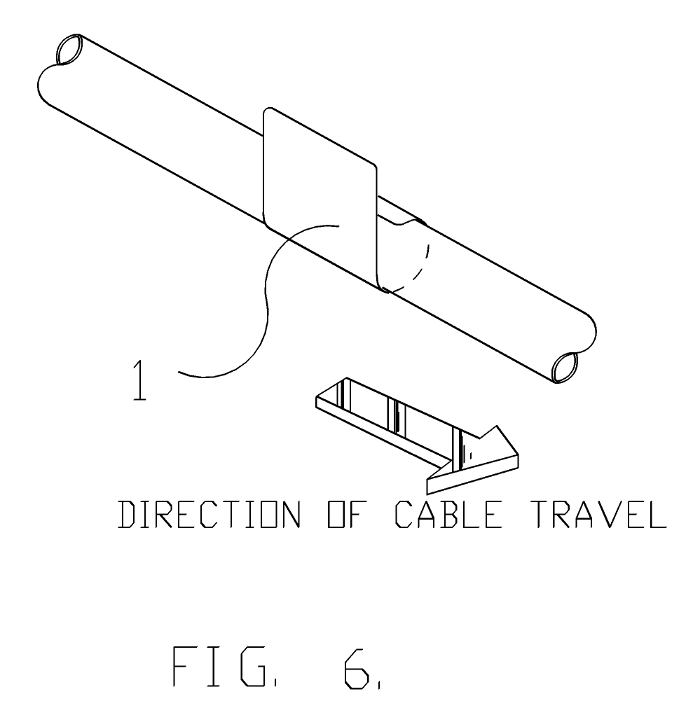

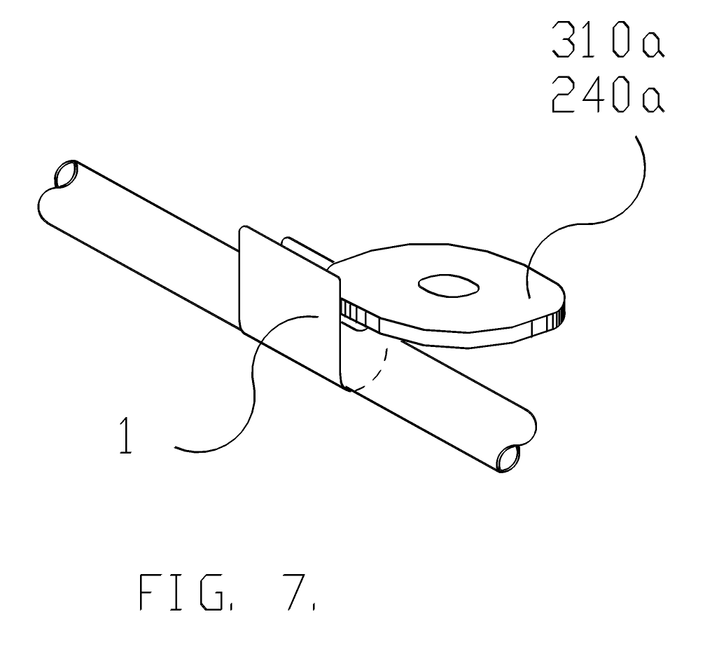

Referring to FIGS. 7-9, down stream of the bottom push up roller 220 is a first roll down roller 310a. The first roll down roller 310a is disposed lateral to a first side of the moving rope 2 and has a channel 230 bounded by side walls 225 and is configured to receive a moving rope having a label partially folded over therewith into a U shape by the bottom push up roller 220. The first roll down roller 310a is configured to fold down a shorter side 241 of the label onto the moving rope 2.

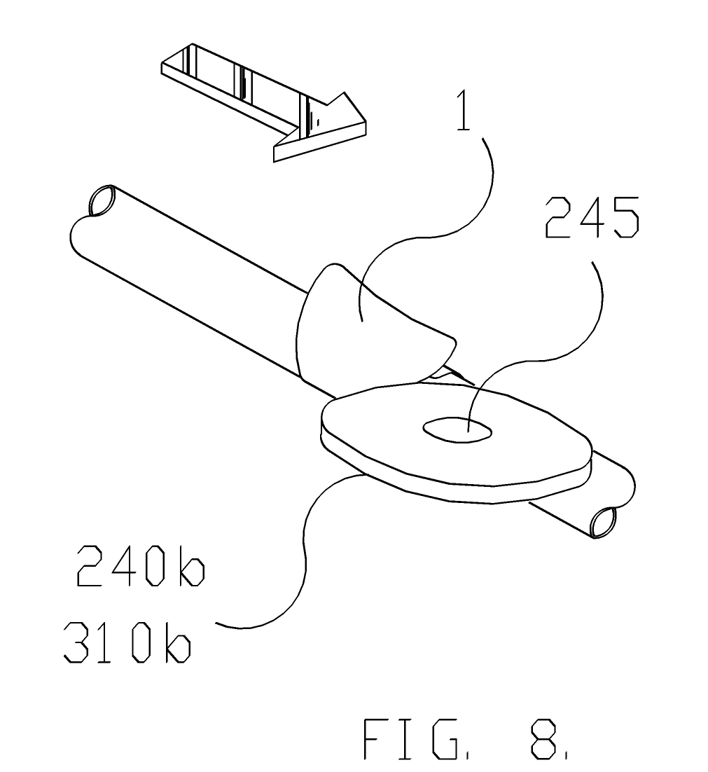

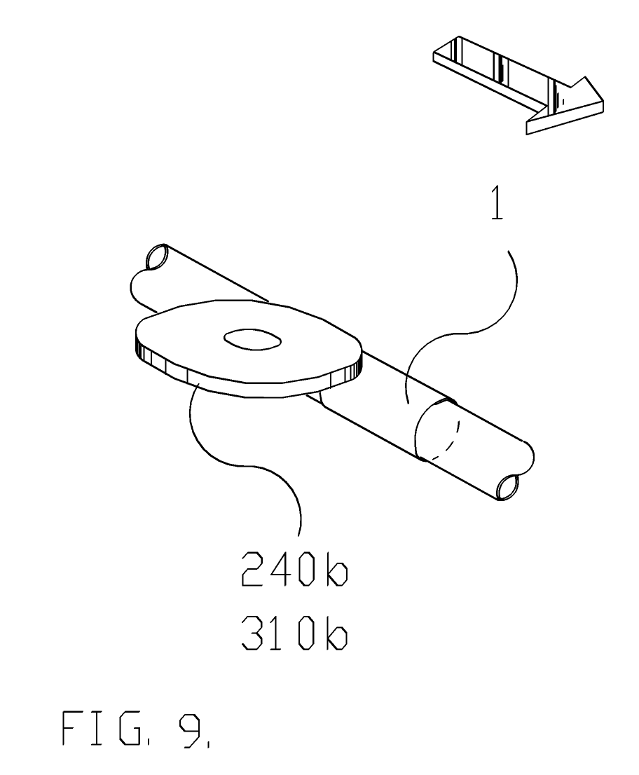

Referring to FIGS. 8 and 9, further down stream is a second roll down roller 310b disposed lateral to a second side of the rope, opposite to the first side. The second roll down roller 310b is configured to receive a moving rope having one shorter side 241 of the label folded down onto the rope 2 by the first roll down roller 310a. The second roll down roller 310b is configured to fold down a longer side 243 of the label onto the moving rope 2 and over the shorter folded down side, with part of the adhesive side of the label affixing to the top of the shorter folded down side.

Referring to FIGS. 10 and 11, downstream of the roll down rollers 310a, 310b is a top push down roller 265. In one embodiment, the top push down roller 265 is solid with no channel and presses the label against the rope to secure attachment. In another embodiment, the top push down roller may be of similar shape to the bottom push up roller 220 and include a channel and side walls for receiving the rope 2.

In another embodiment, illustrated in FIG. 11, a heat tunnel 231 may be provided downstream of the rollers. After the label is affixed, the labeled rope may be treated with hot air or radiant heat to cause the label 1 to shrink, preferably circumferentially. The heat tunnel and all the other components of the method for affixing labels to the rope may be configured to rise out of the way when a scrambled or broken rope or cable approaches the area where the process of labeling is taking place.

In operation, an unlabeled rope or cable 2 moves in a direction in line with its axis as indicated by the thick arrows in the figures. A label dispenser dispenses labels adhered to a backing strip. As the backing strip moves over a peel blade, a label detaches from the backing strip and is caught by the bottom push up roller 220 and is pressed between the cable and the roller 220. As the roller rotates, the label is folded upward onto the sides of the rope so that two sides of the label are upright in a U shape. Next, the folded label moves with the rope into the first roll down roller and one side of the label is folded down. Subsequently, the rope with the label having one side folded down enters the second roll down roller 310b and a side wall pushes down the other side of the label. Subsequently, the labeled rope is moved under the top push down roller to further press the label against the rope.

In one alternative embodiment, shown in FIG. 13 and FIGS. 13A through FIG. 13J, the dispenser and peel blade 305 is oriented to dispense labels perpendicular to the direction of motion of a rope 2 moving along its axis. Referring to FIG. 14, a tamp pad 205 is provided having a U shaped channel 215 disposed in a flat top side 212 of the tamp pad 205. Vacuum ports 214 are disposed on the top side 212 to have a method of receiving and holding labels having an adhesive side facing up dispensed from the peel blade 305. The tamp pad having received a label, moves upward to engage a moving rope 2 into the channel 215, thus folding the label 2 into a U shape in the channel between the tamp pad 205 and the moving rope 2 as depicted in FIGS. 13B through 13D. Depending on the distance between the tamp pad 205 and the peel blade 307, the sides of the label folded in to a U shape will be of differing heights.

Since the rope is moving, the label 2 has traveled off of the tamp pad 205 and the grooved tamp pad returns to a lowered position away from the moving rope 2 and another adhesive backed label may be dispensed onto the tamp pad 205. Vacuum holes 214 in the grooved tamp pad in the flat area of the grooved tamp pad are commencing with a vacuum condition to hold the label in place for a specified period of time until the grooved tamp pad is pressed against the moving rope and another U shaped attachment configuration cycle is repeated.

The labeled rope may then move into a bottom push up roller 220 for further securing the label to the rope. Next, the folded label moves with the rope into the first roll down roller and the shorter side of the label is folded down. Subsequently, the rope with the label having the shorter side folded down enters the second roll down roller 310b and a side wall pushes down the other taller side of the label. Subsequently, the labeled rope is moved under the top push down roller to further press the label against the rope.

In yet a further embodiment, as shown in FIG. 13G1, a second tamp having a channel configured to press down a shorter side of a U shaped label. Downstream, a third tamp pad may press down the other taller side of the label. The second and third tamp pads may be used in place of the roll down rollers 310a, 310b, but otherwise, the components in the above described embodiments may remain the same.

A heat tunnel with a specified opening and a specified length and a specified wattage for heat generation encompasses the moving labeled rope downstream of the rollers. When the moving labeled rope enters the heat tunnel, the heat is controlled specifically for shrinking the label in a specified way without damaging the text on the label. Independent of how large and bold any text displayed on the label is, the label will not absorb too much heat to damage the label. The heat is controllable for different sizes of labeled rope or any armored electrical cable or elongated article.

A release system with a specified range of opening causes the labeling and wrapping mechanisms to part or move away from the moving rope or cable. This is to eliminate damage to the labeling and wrapping mechanisms if damaged, frayed, stringy, etc. sections of rope or cable arrive at the labeling wrapping area.

While various embodiments of the present invention have been described above, it should be understood that they have been presented by way of example only, and not of limitation. Likewise, the various diagrams may depict an example architecture or other configuration for the invention, which is done to aid in understanding the method and functionality that can be included in the invention. The invention is not restricted to the illustrated example architectures or configurations, but the desired methods can be implemented using a variety of alternative architectures and configurations. Indeed, it will be apparent to one of skill in the art how alternative functional, logical or physical partitioning and configurations can be implemented to implement the desired method of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method of attaching an element to a continuously moving, drawn, extruded article, comprising:
(a) providing an element having an element body, the element body having an attaching side thereon,
(b) said attaching side being secured to said continuously moving, drawn, extruded article.

2. The method of claim 1 wherein said element is an informational element containing a device selected from the group consisting of labels, markers, tags, stickers, patches, signs, placards, advisoes, leafs, finials, covers, advertisements, brandishments, decals, canvasses.

3. The method of claim 1 wherein said element body having flexibility.

4. The method of claim 1 wherein said element body mounts and affixes to the entire perimeter of, and is contiguous on, said continuously moving, drawn, extruded article.

5. The method of claim 1 wherein said element body encircles and encompasses the entire perimeter 360 degrees of, and is contiguous on, said continuously moving, drawn, extruded article.

6. The method of claim 1 wherein said element body having sequacious ubiety.

7. The method of claim 1 wherein said element body is xerotic during said attaching to said continuously moving, drawn, extruded article.

8. The method of claim 1 wherein said continuously moving, drawn, extruded article containing a device selected from the group consisting of electrical armored cable, ropes albeit metal wire; plastic; wood; synthetic or natural fiber ropes, cables, wires, conduits, conductors, hoses, tubes, rods, belts, cords, fibers.
Whereby said informational element is perimetrically, permanently and contiguously, attached at said regulated times with optional said overlapping edges, to a continuously moving, drawn, extruded article, to be displayed in an orderly, spaced, automatic fashion without having to manually attach said informational element.
